(19) United States
(12) Patent Application Publication
(10) Pub. No.: US 2008/0205529 A1
(43) Pub. Date: Aug. 28, 2008

(54) USE OF FINE GRANULAR SCALABILITY WITH HIERARCHICAL MODULATION

(75) Inventors: Miska Hannuksela, Ruutana (FI); Vinod Kumar Malamal Vadakital, Tampere (FI)

Correspondence Address: FOLEY & LARDNER LLP, P.O. BOX 80278, SAN DIEGO, CA, 92138-0278, US

(73) Assignee: Nokia Corporation

(21) Appl. No.: 11/971,866

(22) Filed: Jan. 9, 2008

Related U.S. Application Data
(60) Provisional application No. 60/884,848, filed on Jan. 12, 2007.

(51) Int. Cl. H04N 7/26

(52) U.S. Cl. 375/240.26; 375/240.01; 375/E07.2

(57) ABSTRACT

A system and method of hierarchical modulation in scalable media is provided, where the HP bits of a constellation pattern of a hierarchical modulation mode are allocated for an entire base layer of a scalable stream and at least some data from a fine-granular scalable (FGS) enhancement layer. The LP bits of the constellation pattern can be used for the remaining data of the FGS layer. Concatenation of the FGS data in the HP bits and in the LP bits provides a valid FGS layer. Therefore, problems associated with redundant data padding resulting in inefficient resource utilization, increased complexity related to accurate bitrate control algorithms, time-varying picture quality, and maintaining identical bitrate shares between base and enhancement layers and HP and LP bits, are avoided.

### CROSS-REFERENCE TO RELATED APPLICATIONS

The present application claims priority to U.S. Provisional Patent Application No. 60/884,848, filed Jan. 12, 2007.

### FIELD OF THE INVENTION

The present invention relates generally to video coding. More particularly, the present invention relates to allocating high-priority bits and low-priority bits for base layers and enhancement layers for transmitting and receiving a digital broadcast signal using hierarchical modulation.

### BACKGROUND OF THE INVENTION

This section is intended to provide a background or context to the invention that is recited in the claims. The description herein may include concepts that could be pursued, but are not necessarily ones that have been previously conceived or pursued. Therefore, unless otherwise indicated herein, what is described in this section is not prior art to the description and claims in this application and is not admitted to be prior art by inclusion in this section.

Video coding standards include ITU-T H.261, ISO/IEC MPEG-1 Visual, ITU-T H.262 or ISO/IEC MPEG-2 Visual, ITU-T H.263, ISO/IEC MPEG-4 Visual and ITU-T H.264 (also know as ISO/IEC MPEG-4 AVC). In addition, there are currently efforts underway with regards to the development of new video coding standards. One such standard under development is the scalable video coding (SVC) standard, which will become the scalable extension to H.264/AVC. Another standard under development is the multi-view coding standard (MVC), which is also an extension of H.264/AVC. Yet another such effort involves the development of China video coding standards.

The latest draft of the SVC is described in JVT-U201, “Joint Draft 8 of SVC Amendment”, 21^{st} JVT meeting, HangZhou, China, October 2006, available at ftp3.itu.ch/av-arch/jvt-site/2006_{—}10_Hangzhou/JVT-U201.zip. The latest draft of MVC is in described in JVT-U209, “Joint Draft 1.0 on Multiview Video Coding”, 21^{st} JVT meeting, HangZhou, China, October 2006, available at ftp3.itu.ch/av-arch/jvt-site/2006_{—}10_Hangzhou/JVT-U209.zip. Both of these documents are incorporated herein by reference in their entireties.

Scalable media is typically ordered into hierarchical layers of data. A base layer contains an individual representation of a coded media stream such as a video sequence. Enhancement layers contain refinement data relative to previous layers in the layer hierarchy. The quality of the decoded media stream progressively improves as enhancement layers are added to the base layer. An enhancement layer enhances the temporal resolution (i.e., the frame rate), the spatial resolution, or simply the quality of the video content represented by another layer or part thereof. Each layer, together with all of its dependent layers, is one representation of the video signal at a certain spatial resolution, temporal resolution and quality level. Therefore, the term “scalable layer representation” is used herein to describe a scalable layer together with all of its dependent layers. The portion of a scalable bitstream corresponding to a scalable layer representation can be extracted and decoded to produce a representation of the original signal at a certain fidelity.

In some cases, data in an enhancement layer can be truncated after a certain location, or at arbitrary positions, where each truncation position may include additional data representing increasingly enhanced visual quality. In cases where the truncation points are closely spaced, the scalability is said to be “fine-grained”, hence the term “fine grained (granular) scalability” (FGS). In contrast to FGS, the scalability provided by those enhancement layers that can only be truncated at certain coarse positions is referred to as “coarse-grained (granularity) scalability” (CGS).

The scalable extension (SVC) of H.264/AVC described herein is utilized for the purposes of illustration and description. It should be noted that other video specifications, such as MPEG-4 Visual, contain similar features to SVC and could be used as well. In addition, other media types, such as audio, have coding formats with features similar to SVC that could be described as well in conjunction with the various embodiments of the present invention, described in detail below.

SVC uses a similar mechanism as that used in H.264/AVC to provide hierarchical temporal scalability. In SVC, a certain set of reference and non-reference pictures can be dropped from a coded bistream without affecting the decoding of the remaining bitstream. Hierarchical temporal scalability requires multiple reference pictures for motion compensation, i.e., there is a reference picture buffer containing multiple decoded pictures from which an encoder can select a reference picture for inter prediction. In H.264/AVC a feature called sub-sequences enables hierarchical temporal scalability, where each enhancement layer contains sub-sequences and each sub-sequence contains a number of reference and/or non-reference pictures. The sub-sequence is also comprised of a number of inter-dependent pictures that can be disposed without any disturbance to any other sub-sequence in any lower sub-sequence layer. The sub-sequence layers are hierarchically arranged based on their dependency on each other. Therefore, when a sub-sequence in the highest enhancement layer is disposed, the remaining bitstream remains valid. In H.264/AVC, signaling of temporal scalability information is effectuated by using sub-sequence-related supplemental enhancement information (SEI) messages. In SVC, the temporal level hierarchy is indicated in the header of Network Abstraction Layer (NAL) units.

SVC uses an inter-layer prediction mechanism, whereby certain information can be predicted from layers other than a currently reconstructed layer or a next lower layer. Information that could be inter-layer predicted includes intra texture, motion and residual data. Inter-layer motion prediction also includes the prediction of block coding mode, header information, etc., where motion information from a lower layer may be used for predicting a higher layer. It is also possible to use intra coding in SVC, i.e., a prediction from surrounding macroblocks or from co-located macroblocks of lower layers. Such prediction techniques do not employ motion information and hence, are referred to as intra prediction techniques. Furthermore, residual data from lower layers can also be employed for predicting the current layer.

In comparison to previous video compression standards, spatial scalability in SVC has been generalized to enable a base layer to be a cropped and zoomed version of an enhancement layer. Associated quantization and entropy coding modules have also been adjusted to provide FGS capability. The coding mode is referred to as progressive refinement, where successive refinements of transform coefficients are encoded by repeatedly decreasing the quantization step size and applying a “cyclical” entropy coding akin to sub-bitplane coding.

SVC also specifies a concept referred to as “single-loop decoding.” Single-loop decoding is enabled by utilizing a constrained intra texture prediction mode, whereby the inter-layer, intra texture prediction can be applied to macroblocks (MBs) for which a corresponding block of a base layer is located inside intra-MBs. At the same time, those intra-MBs in the base layer use constrained intra prediction. In single-loop decoding, a decoder needs to perform motion compensation and full picture reconstruction only for that scalable layer which is desired for playback (e.g., the desired layer), thereby greatly reducing decoding complexity. All of the layers other than the desired layer do not need to be fully decoded because all or part of the data of the MBs not used for inter-layer prediction (whether it be inter-layer, intra texture prediction, inter-layer motion prediction, or inter-layer residual prediction) is not needed for reconstructing the desired layer.

It should be noted that a single decoding loop is needed to decode most pictures, while a second decoding loop is applied to reconstruct the base representations, which are needed for prediction reference purposes, but not for output or display purposes. In addition, the base representations are reconstructed selectively only when a store_base_representation_flag is set equal to 1.

Digital broadband wireless broadcast technologies, such as Digital Video Broadcasting—handheld (DVB-H), Digital Video Broadcasting—Terrestrial (DVB-T), Digital Multimedia Broadcast-Terrestrial (DMB-T), Terrestrial Digital Multimedia Broadcasting (T-DMB), Multimedia Broadcast Multicast Service (MBMS), and MediaFLO (Forward Link Only) are examples of technologies that can be used for building multimedia content broadcasting services. DVB-H is described in detail below for the purposes of illustrating and describing background information regarding hierarchical modulation, although it should be understood that other technologies, such as those noted above, could be relevant to hierarchical modulation as well.

One characteristic of the DVB-T/H standard is the ability to build networks that are able to use hierarchical modulation. Generally, such systems share the same RF channel for two independent multiplexes. In hierarchical modulation, the possible digital states of a constellation (i.e., 64 states in the case of 64-QAM and 16 states in the case of 16-QAM) are interpreted differently than in a non-hierarchical case. In particular, two separate data streams can be made available for transmission: a first stream, referred to as High Priority (HP) is defined by the number of the quadrant in which the state is located (e.g., a special Quadrature Phase Shift Keying (QPSK) stream); and a second stream, referred to as Low Priority (LP) is defined by the location of the state within its quadrant (e.g., a 16-QAM or a QPSK stream). More general hierarchical modulation modes involving more than bit allocation to more than two priorities can also be derived.

Bitrate control in video coding is also of importance. Conventionally, bit-rate control algorithms are divided into various processes. In a first process, a bit budget is allocated to a video part, such as a GOP (Group of Pictures), a coded picture, or a macroblock, according to practical constraints and desired/required video properties. In a second process, a quantization parameter (QP) is computed according to the allocated bit budget and the coding complexity of the video. In conventional systems, a rate-distortion (RD) model is utilized for the computation of the QP. The RD model is derived analytically or empirically. With regard to analytical modeling, the RD model is derived according to the statistics of the source video signal and the properties of encoder. Empirical modeling attempts to approximate the RD curve by interpolating between a set of sample points. The RD model provided by one of the two approaches is then employed in the bit budget allocation process and calculation of the QP for the rate control.

Referring again to DVB-H, the physical DVB-H physical layer uses QAM in its physical layer to transmit information. The three QAM constellation types used for the DVB-H physical layer are QPSK or 4 QAM, 16 QAM and 64 QAM. QPSK has four constellation points (one point per quadrant) (depicted in FIG. 6(a)), 16 QAM has 16 constellation points (four points per quadrant) (depicted in FIG. 6(b)) and 64 QAM has 64 constellation points (16 points per quadrant) (depicted in FIG. 6(c)). Each constellation point in a QAM constellation point is modulated by carrier waves of different amplitude and phase.

Each constellation point in a QAM constellation map is assigned a codeword. A QPSK constellation point has a codeword length of 1 bit, 16 QAM has a codeword length of 4 bits and 64 QAM has a codeword length of 6 bits. A digital bitstream that is to be transmitted is first segmented into symbols of appropriate length depending on the QAM constellation that is used. For example, if a 16 QAM constellation is used, a bitstream 1010001010100010000010101 is broken and segmented into 4 bit symbols {1010, 0010, 1010, 0010, 0001, 0101}. These symbols are mapped to the constellation point which has the same codeword as the symbol itself, before being modulated by a carrier wave pertinent to the codeword.

When hierarchical modulation is used, the code words that are assigned to the constellation points are such that two bitstreams (referred to as high priority and low priority) can be multiplexed together. An example of codeword mapping in a 16 QAM constellation for hierarchical mapping is depicted in FIG. 7. Bits of the high priority bitstream occupy the first two most significant bits, while bits of the low priority bitstream occupy the other two bits. For example, if the high priority bitstream is 1000 1010 0100 1001 0010 and the the low priority bitstream is 1110 1101 0110 1010 1111, then the multiplex of the two bitstream is {1011, 0010, 1011, 1001, 0101, 0010, 1010, 0110, 0011, 1011}. Upon a false detection of the symbol, the receiver has a higher probability of correctly detecting the bits of the higher priority stream than the lower priority stream than it does for the lower priority stream.

Coded video has an inherently variable bitrate due to highly predictive coding and efficient entropy coding with variable length codes. The amount of tolerable variation depends on the application to which the coded sequence is provided. For example, a critical factor for good end-user experience in conversational video communication services, such as video telephony, is very low end-to-end delay. Because many transmission channels can provide a constant bitrate or can limit a maximum bitrate, video bitrate variation results in varying transmission delays through the transmission channel. However, picture rate stabilization can be implemented in a receiver by initial buffering, where the buffer duration is relative to the delay variation occurring in the constant-bit-rate channel. Other applications, such as unicast streaming, are flexible so as to allow for longer initial buffering as compared to conversational video applications. Consequently, a larger video bitrate variation can be allowed. The longer the initial buffering duration, the more stable the picture quality becomes.

A hypothetical reference decoder (HRD) or a video buffer verifier (VBV), as it is referred to in, e.g., MPEG-4 Visual, is used to check bitstream and decoder conformance. The HRD of H.264/AVC and its extensions contain a coded picture buffer (CPB), an instantaneous decoding process, a decoded picture buffer (DPB), and an output picture cropping block. The CPB smooths out differences between a (piece-wise) constant input bitrate and the video bitrate due to a determined amount of initial buffering. Coded pictures are removed from the CPB at a certain pace and decoding is considered to occur immediately. The DPB is used to arrange pictures in output order, and to store reference pictures for inter prediction. A decoded picture is removed from the DPB when it is no longer used as a reference or is no longer needed for output. The output picture cropping block simply crops those samples from the decoded picture that are outside of the signaled output picture boundaries.

International Patent Publication No. WO 2006/125850 to Väre,and U.S. Pat. No. 6,909,753 to Meehan et al., both incorporated herein by reference in their entireties, suggest that a base layer and an enhancement layer of a scalable media stream can be transmitted in high priority (HP) and low priority (LP) bits, respectively, in a layered modulation mode. The use of layered coding with hierarchical modulation has been reported to improve error resilience because the probability of correct reception of HP bits is higher than the probability of correct reception of LP bits or the bits in a corresponding non-hierarchical modulation mode.

The Meehan et al. reference described above also suggest mapping the base layer and the enhancement layer to the HP bits and LP bits, respectively, of the NC56686US constellation pattern of the hierarchical modulation mode in use, where the numbers of HP bits and LP bits have a certain pre-determined share dependent on the hierarchical modulation mode in use. It should be noted that the modulation mode may be changed as a function of time, for example based on an adaptation similar to that proposed in the Meehan et al. reference. However, the share of the HP and LP bits remains constant within a time window in which the same modulation mode is used. Hence, the problem can be simplified if only a pre-determined share between HP and LP bits were to be considered.

However, problems still arise when considering a pre-determined share between HP and LP bits. The share between the bitrates of the base layer and the enhancement layer should be exactly identical to the share between HP and LP bits. Otherwise, one of the layers should be padded with redundant data to avoid losing the synchronization of the layers. However, padding with redundant data is a naturally insufficient use of radio resources, and drops the amount of video bitrate that can be carried compared to the corresponding non-hierarchical modulation mode. In addition, due to the inherent varying bitrate nature of coded video, matching the bitrates of the base layer and enhancement layer exactly to the share of the HP and LP bits is difficult with any rate control algorithm. Therefore, the implementation and processing complexity of accurate rate control algorithms can be significant. Furthermore, the more accurate the bitrate match of base and enhancement layers is to the share of HP and LP bits, the more the picture quality will vary as a function of time. However, time-varying picture quality can be inconvenient or annoying for end-users. Lastly, the share of HP and LP bits may not be known at the time of encoding, e.g., when the content is prepared off-line. Consequently, it may not be possible to encode a stream having the base and enhancement layer bitrate share that is identical to the HP and LP bit share. Therefore, it would be desirable to provide a system and method of hierarchical modulation that is not susceptible to the above problems.

### SUMMARY OF THE INVENTION

According to various embodiments of the present invention, the HP bits of a constellation pattern of a hierarchical modulation mode are allocated for an entire base layer of a scalable stream and at least some data from a FGS enhancement layer. The LP bits of the constellation pattern can be used for the remaining data of the FGS layer. Concatenation of the FGS data in the HP bits and in the LP bits provides a valid FGS layer. Therefore, problems associated with redundant data padding resulting in inefficient resource utilization, increased complexity related to accurate bitrate control algorithms, time-varying picture quality, and maintaining pre-determined bitrate shares between base and enhancement layers and HP and LP bits, are avoided.

These and other advantages and features of the invention, together with the organization and manner of operation thereof, will become apparent from the following detailed description when taken in conjunction with the accompanying drawings, wherein like elements have like numerals throughout the several drawings described below.

### BRIEF DESCRIPTION OF THE DRAWINGS

FIG. 1 illustrates an IP data casting (IPDC) over DVB-H system within which the various embodiments of the present invention may be implemented;

FIG. 2 is a perspective view of a mobile device that can be used in the implementation of the present invention;

FIG. 3 is a schematic representation of the device circuitry of the mobile device of FIG. 2;

FIG. 4 illustrates an example of prediction dependencies in accordance with a FGS coded bitstream;

FIG. 5A illustrates an example of a priority mechanism for NAL units using basic extraction;

FIG. 5B illustrates an example of quality layer-based extraction;

FIG. 6A is a graphical representation of the QSPK constellation type;

FIG. 6B is a graphical representation of the 16 QAM constellation type;

FIG. 6C is a graphical representation of the 64 QAM constellation type; and

FIG. 7 shows an example of codeword mapping in a 16 QAM constellation for hierarchical mapping.

### DETAILED DESCRIPTION OF VARIOUS EMBODIMENTS

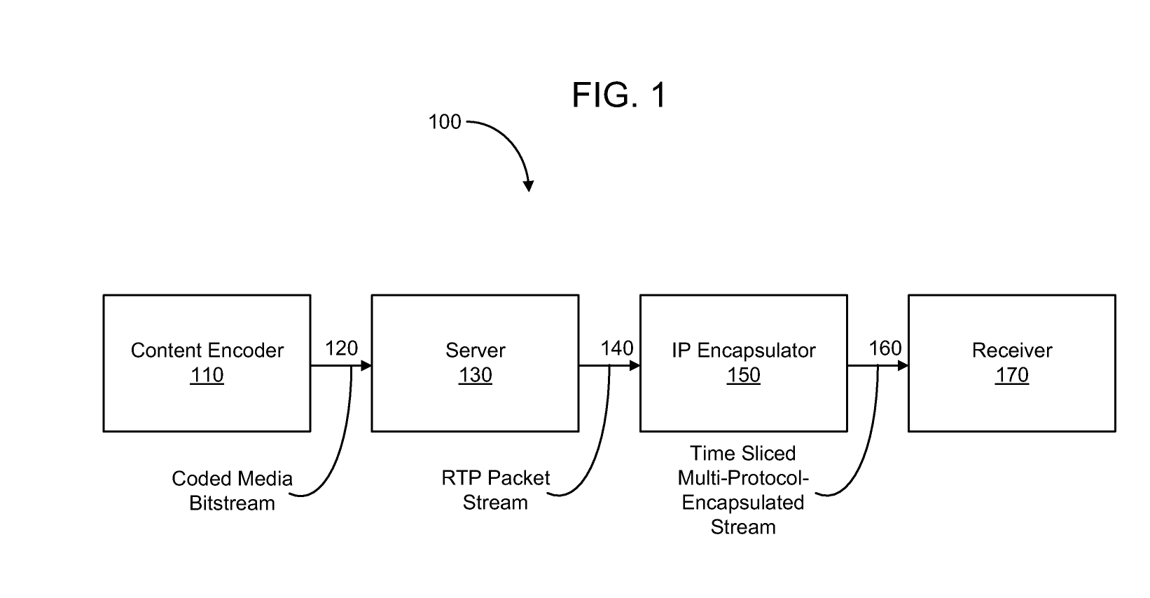

A simplified block diagram of an IP data casting (IPDC) over DVB-H system 100 for use with the various embodiments of the present invention is depicted in FIG. 1. A content encoder 110 receives a source signal (not shown) in analog, uncompressed digital, or compressed digital format. Alternatively, the source signal can be formatted using any combination of these formats. The content encoder 110 encodes the source signal into a coded media bitstream. It should be noted that the content encoder 110 is capable of encoding more than one media type, such as audio and video. In addition, more than one content encoder may be utilized to code different media types within the source signal. The content encoder 110 can also receive synthetically produced input, such as graphics and text, or it can be capable of producing coded bitstreams of synthetic media. Herein, the processing of one coded media bistream of one media type is described in order to simplify the description. However, conventional, real-time broadcast services can often comprise several streams, e.g., at least one audio, one video, and one text sub-titling stream. It should also be noted that a system can include many content encoders, although the description contained herein only discusses one content encoder in order to simplify the description without lack of generality.

It should be understood that, although text and examples contained herein may specifically describe an encoding process, one skilled in the art would readily understand that the same concepts and principles also apply to the corresponding decoding process, described below, and vice versa.

At 120, the coded media bitstream is transferred to a server 130. The format used in the transmission may be an elementary self-contained bitstream format, a packet stream format, or one or more coded media bitstreams may be encapsulated into a container file. The content encoder 110 and the server 130 can reside in the same physical device or they may be implemented in separate devices. The content encoder 110 and the server 130 can operate with live, real-time content. Therefore, the coded media bitstream need not be stored permanently, but rather buffered for small periods of time in the content encoder 110 and/or in the server 130 to smooth out variations in processing delay, transfer delay, and the coded media bitrate. The content encoder 110 can also be operated well before the bitstream is transmitted from the server 130. In this case, the system 100 may include a content database (not shown), which can reside in a separate device or in the same device that the content encoder 110 and/or the server 130 reside.

The server 130 can be a conventional Internet Protocol (IP) Multicast server using real-time media transport over Real-Time Transport Protocol (RTP). The server 130 encapsulates the coded media bitstream into RTP packets according to an RTP payload format for transmission to an IP encapsulator 150. Each media type can have a dedicated RTP payload format. It should be noted again that the system 100 may contain more than one server (not shown), but for the sake of simplicity, the description herein considers one server.

The server 130, as noted above, is connected to the IP encapsulator 150 (a.k.a. a Multi-Protocol Encapsulator, MPE or MPE encapsulator). The connection between the server 130 and an IP network can comprise a fixed-line private network. The IP encapsulator 150 packetizes IP packets into Multi-Protocol Encapsulation (MPE) Sections which are further encapsulated into MPEG-2 Transport Stream packets. The IP encapsulator 150 can optionally use MPE-FEC error protection, described in greater detail below.

MPE-FEC is based on Reed-Solomon (RS) codes, and is included in the DVB-H specifications to counter high levels of transmission errors. The RS data is packed into a special MPE section so that an MPE-FEC-ignorant receiver can simply ignore MPE-FEC sections.

An MPE-FEC frame is arranged as a matrix with 255 columns and a flexible number of rows. Each position in the matrix hosts an information byte. The first 191 columns are dedicated to Open Source Initiative (OSI) layer 3 datagrams (hereinafter referred to as “datagrams”) and possible padding. This part of the MPE-FEC frame is called the application data table (ADT). The next 64 columns of the MPE-FEC frame are reserved for RS parity information and what is referred to as the RS data table (RSDT). The ADT can be completely or partially filled with datagrams. The remaining columns, when the ADT is only partially filled, are padded with zero bytes and are called padding columns. Padding can also be done when there is no more space left in the MPE-FEC frame to fill the next complete datagram. The RSDT is computed across each row of the ADT using an RS (255, 191) code. It is not necessary to compute the entire 64 columns of the RSDT and some of its right-most columns could be completely discarded in a process referred to as “puncturing.” As a result, the padded and punctured columns are not sent over the transmission channel.

The process of receiving, demodulating and decoding of a full bandwidth DVB-T signal would require substantial power, and such power is not at the disposal of small, handheld, battery-operated devices. To reduce power consumption in handheld terminals, service data is time-sliced (typically by the IP encapsulator 150) before it is sent into the channel. When time-slicing is used, the data of a time-sliced service is sent into the channel as bursts at 160, so that a receiver 170, using the control signals, remains inactive when no bursts are to be received. This reduces the power consumption in the receiver terminal. The bursts are sent at a significantly higher bitrate, and an inter-time-slice period is computed such that the average bitrate across all time-sliced bursts of the same service is the same as when conventional bitrate management is used. For downward compatibility between DVB-H and DVB-T, the time-sliced bursts can be transmitted along with non-time-sliced services.

Time-slicing in DVB-H uses the “delta-t” method to signal the start of the next burst. The timing information delivered using the delta-t method is relative and is the difference between the current time and the start of the next burst. The use of the delta-t method for signalling the start of the next burst removes the need for synchronization between a transmitter and a receiver. Its use also provides increased flexibility because parameters such as burst size, burst duration, burst bandwidth, and off-times can be freely varied between elementary streams as well as between bursts within an elementary stream.

It should also be noted that the IP encapsulator 150 can act or be implemented as a gateway, which may perform different types of functions other than or in addition to those described above, such as translation of a packet stream according to one communication protocol stack to another communication protocol stack, merging and forking of data streams, and manipulation of data stream according to the downlink and/or receiver capabilities, such as controlling the bitrate of the forwarded stream according to prevailing downlink network conditions. Other examples of gateways, besides that of an IP encapsulator, include multipoint conference control units (MCUs), gateways between circuit-switched and packet-switched video telephony, Push-to-talk over Cellular (PoC) servers, or set-top boxes that forward broadcast transmissions locally to home wireless networks. When RTP is used, the gateway can be referred to as an RTP mixer or an RTP translator, and may act as an endpoint of an RTP connection.

The IP datacasting over DVB-H system 100 further includes a radio transmitter (not shown) for modulating and transmitting an MPEG-2 transport stream signal over a radio access network. As the radio transmitter is not essential for the operation of the present invention, to be described below, it is not discussed further. In fact, the various embodiments of the present invention are relevant to any wireless or fixed access network.

It should be noted that the receiver 170 is capable of receiving, de-modulating, de-capsulating, decoding, and rendering a transmitted signal, e.g., the time sliced, MPE stream, resulting into one or more uncompressed media streams. However, the receiver 170 can also contain only a part of these functions. For example, the receiver 170 can be configured to carry out the receiving and de-modulation processes, and then forward the resulting MPEG-2 transport stream to another device, such as a decoder (not shown) configured to perform any of the remaining processes described above. Lastly, a renderer (not shown) may reproduce the uncompressed streams with a loudspeaker or a display, for example. The receiver 170, the decoder, and the renderer may reside in the same physical device or they may be included in separate devices.

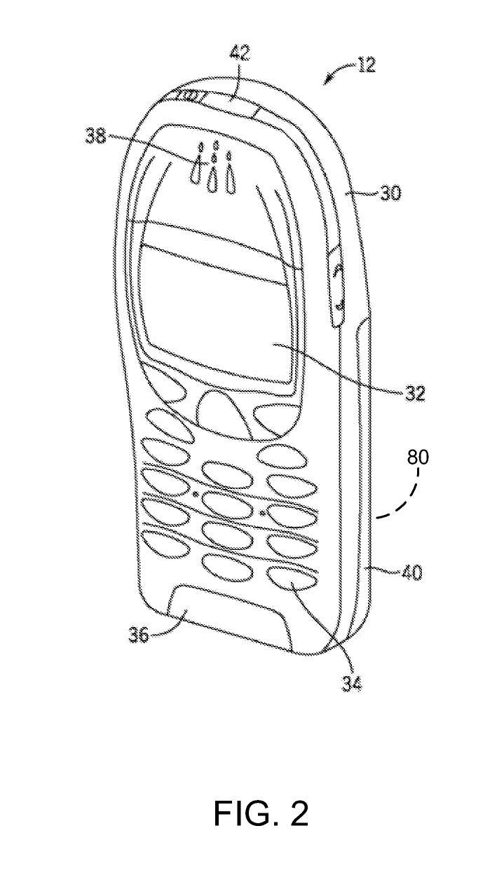

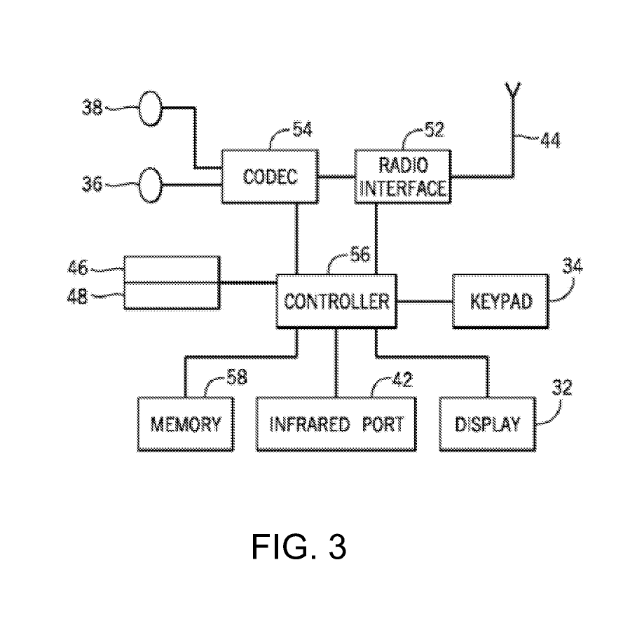

FIGS. 2 and 3 show an example implementation as part of a communication device (such as a mobile communication device like a cellular telephone, or a network device like a base station, router, repeater, etc.). However, it is important to note that the present invention is not limited to any type of electronic device and could be incorporated into devices such as personal digital assistants, personal computers, mobile telephones, and other devices. It should be understood that the present invention could be incorporated on a wide variety of devices.

The device 12 of FIGS. 2 and 3 includes a housing 30, a display 32, a keypad 34, a microphone 36, an ear-piece 38, a battery 40, a battery and/or back cover 80, radio interface circuitry 52, codec circuitry 54, a controller 56 and a memory 58. Individual circuits and elements are all of a type well known in the art, for example in the Nokia range of mobile telephones. The exact architecture of device 12 is not important. Different and additional components of device 12 may be incorporated into the device 12. The scalable video encoding and decoding techniques of the present invention could be performed in the controller 56 memory 58 of the device 12.

According to the various embodiments of the present invention, a system and method of generating a carrier wave signal using a hierarchical modulation mode is provided. The hierarchical modulation mode can be configured to convey an HP stream and an LP stream, where HP bits of a constellation pattern of the hierarchical modulation mode are allocated for an entire base layer of a scalable stream and at least some data from a fine-granular scalable (FGS) enhancement layer. LP bits of the constellation pattern can be used for the remaining data of the FGS layer. However, it should be noted that the remaining data of the FGS layer does not have to fit into LP bits in its entirety but rather can be truncated according to the capacity provided by LP bits. Concatenation of the FGS data in the HP bits and in the LP bits provides a valid FGS layer. In addition a carrier wave signal comprising a waveform that is hierarchically modulated in accordance with the various embodiments of the present invention is provided.

The content encoder 110 in one embodiment of the present invention comprises an SVC encoder. It encodes at least two layers, i.e., a base layer and an FGS enhancement layer. The content encoder 110 may also encode more FGS enhancement layers as explained in greater detail below.

A base layer is encoded with a constant QP that is considered sufficient for a base quality service and results in an approximate, desired bitrate. In turn, the bitrate of the base layer should not exceed a limit derived from the number of available HP bits and the maximum allowed time-slice burst frequency for the service. An FGS enhancement layer is also encoded. The FGS enhancement layer is approximately equal to the base layer in terms of the number of bits used to encode the base layer.

A simple bitrate control algorithm can be used to adjust the QP if the bitrates deviate too far from the desired bitrates. Additionally, an HRD verifier block may be used to check that the bit stream complies with the HRD constraints, and to control the QP to avoid violations in the HRD buffers. The share of HP and LP bits can be provided to the encoder and its bitrate control algorithm for deriving the target bitrates of different layers, although doing so is unnecessary because of the use of FGS, as will be explained below. In addition, if it is anticipated that one FGS layer is not sufficient to satisfy the assumed share of HP and LP bits (when HP and LP bits are assigned, as described below), more than one FGS layer can be encoded.

The share of HP and LP bits is provided to the server 130. The server 130 creates two RTP sessions, one session for the HP bits and another session for the LP bits. The RTP streams are associated with each other using media decoding dependency signaling for the Session Description Protocol (SDP) (as which can be found at www.ietf org/internet-drafts/draft-schierl-mmusic-layered-codec-02.txt, and incorporated herein by reference in its entirety). The RTP streams are transmitted to the IP encapsulator(s) 150 using unicast or multicast broadcasting. The draft RTP payload specification for SVC, available at www.ietf.org/internet-drafts/draft-ietf-avt-rtp-svc-00.txt, and incorporated herein by reference in its entirety, contains a description of how an SVC stream is encapsulated to RTP packets. The server 130 adjusts the bitrates of the two streams by including (leading) parts of FGS slices to the RTP stream for the HP bits, and possibly omitting some of the tailing parts of the FGS slices from the LP bits. Allocating the FGS bits for the HP bits and LP bits is described greater detail below.

The IP encapsulator 150 receives both RTP streams, and creates a pair of MPE-FEC matrices, one MPE-FEC matrix per RTP stream for each desired playback range. The desired playback ranges approximately match the cumulative intervals between the time-sliced bursts. In addition, the sizes of the RS data tables should be commensurate with the share of HP and LP bits. MPE and MPE-FEC sections are computed conventionally for both MPE-FEC matrices. The MPE and MPE-FEC sections are further encapsulated in MPEG-2 Transport Stream packets that are transmitted to a radio transmitter. Note that the value of the packet identifier (PID) in the MPEG-2 TS packets may indicate which RTP stream the content belongs to. In other words, because the two RTP streams are different IP streams, each RTP stream can be associated with a different PID value. The radio transmitter in turn, allocates the HP and LP bits for the corresponding MPEG-2 transport stream packets according to the value of their associated PIDs.

The receiver 170 operates as follows. The received HP and LP bits are mapped to MPEG-2 TS packets. A pair of MPE-FEC matrices is formed based on the received MPEG-2 TS packets and decoded when the matrices are complete resulting in RTP packets. Based on the media decoding dependency signaling given in the SDP, the RTP decapsulator, in or operating in conjunction with, the receiver 170 associates the two received RTP streams with each other. The RTP payload decapsulator then reassembles a single SVC bit stream based on the process provided in the draft RTP payload specification for SVC referenced above.

The following describes the operation of the system 100 according to two embodiments of the present invention relating to the allocation of FGS bits for the HP and LP bits. There are two options with regard to the block in which the allocation of data to HP and LP bits is made. According to a first option, the share of HP and LP bits is provided to the server 130. The server 130 creates separate RTP packets targeted for the HP bits and LP bits, where the fragmentation units of the RTP payload format for SVC are used to segment FGS slices to different RTP packets. The RTP packets are then transmitted as a single RTP stream to the IP encapsulator 150. IPv6 flow labels may be used to separate the packets targeted for the HP and LP bits.

In a second option, the share of HP and LP bits may be provided to the server 130, taking into consideration that the server 130 can omit the sending of some FGS data to meet the bit rate share. The server 130 encapsulates the RTP packets conventionally and transmits a single RTP stream to the IP encapsulator 150. The IP encapsulator 150 re-encapsulates the RTP packets such that a set of RTP packets corresponds to the HP bits and another set of RTP packets corresponds to the LP bits, similar to what was described above.

The IP encapsulator 150 creates a pair of MPE-FEC matrices, one MPE-FEC matrix for HP bits and another one for LP bits, for each desired playback range. The desired playback ranges approximately match the cumulative intervals between the time-sliced bursts. The sizes of the RS data tables should match with the share of HP and LP bits. MPE and MPE-FEC sections are computed conventionally for both of the MPE-FEC matrices. The resulting MPEG-2 Transport Stream packets are then transmitted to a radio transmitter. It should be noted that the MPEG-2 TS packets should contain or at least be associated with information regarding whether they correspond to the HP or the LP bits. Lastly, the radio transmitter allocates HP and LP bits to the corresponding MPEG-2 TS packets, and the receiver 170 operates in a substantially similar manner to the operation described above.

Optimal coding efficiency of the FGS pictures in SVC is maintained with a technique known as leaky prediction. That is, an FGS picture is predicted from a previous FGS picture(s) in the same FGS layer (i.e., in this case, temporal prediction) as well as the base picture for the FGS picture (i.e., using inter-layer prediction). The relative weights between temporal and inter-layer prediction for single blocks can be selected, while truncation of an FGS picture causes a drift to any subsequent FGS picture that is directly or indirectly predicted from it. However, the weighting mechanism provides a way to attenuate the drift. Additionally, a base representation may be used for prediction to stop the drift altogether. Furthermore, a temporal scalability hierarchy helps to limit the propagation of the drift.

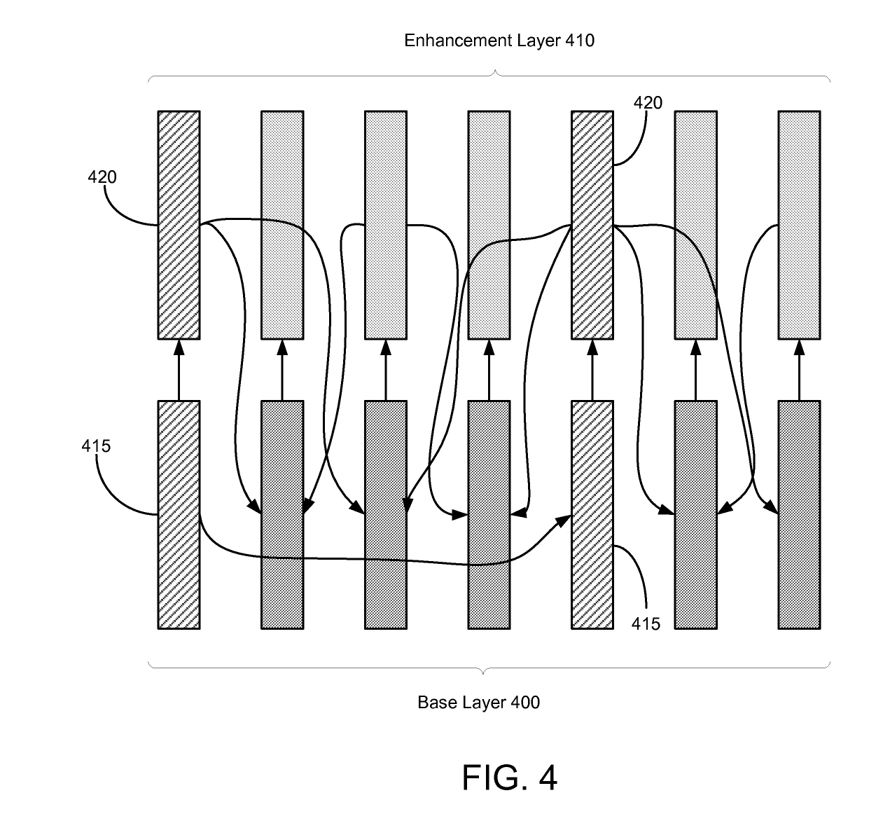

FIG. 4 shows an example of a coded base layer 400 and an FGS enhancement layer 410 with prediction arrows indicating a box and/or a layer from which a prediction is made. Hatched boxes 415 and 420 represent pictures for which the base representation is stored or used.

Therefore, the importance of FGS pictures is a descending function of the temporal level. Consequently, an uneven amount of bits from FGS pictures in different temporal levels may be included in the HP bits as long as the temporal variation of the quality of pictures does not result in an inconvenient, i.e., annoying, result for an end-user. Studies have been made regarding rate-distortion optimized extraction paths in which the layers and the amount of FGS data may vary per picture to produce an optimal resulting bitstream in the rate-distortion sense.

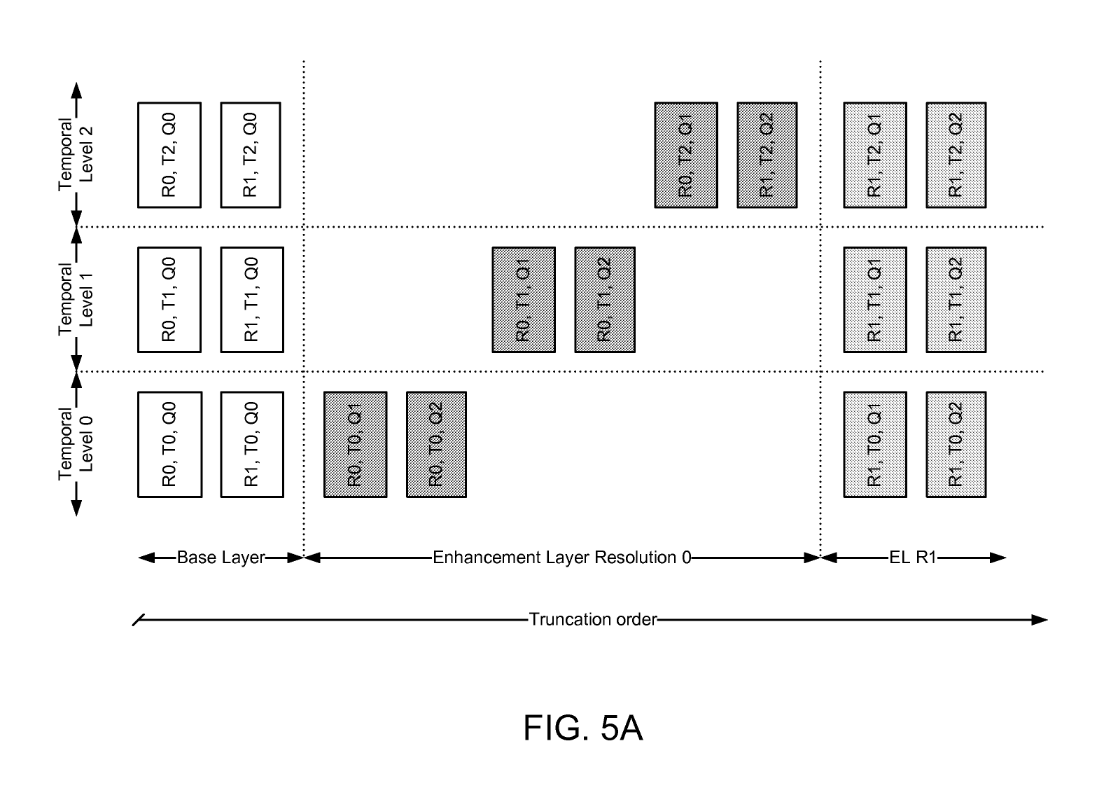

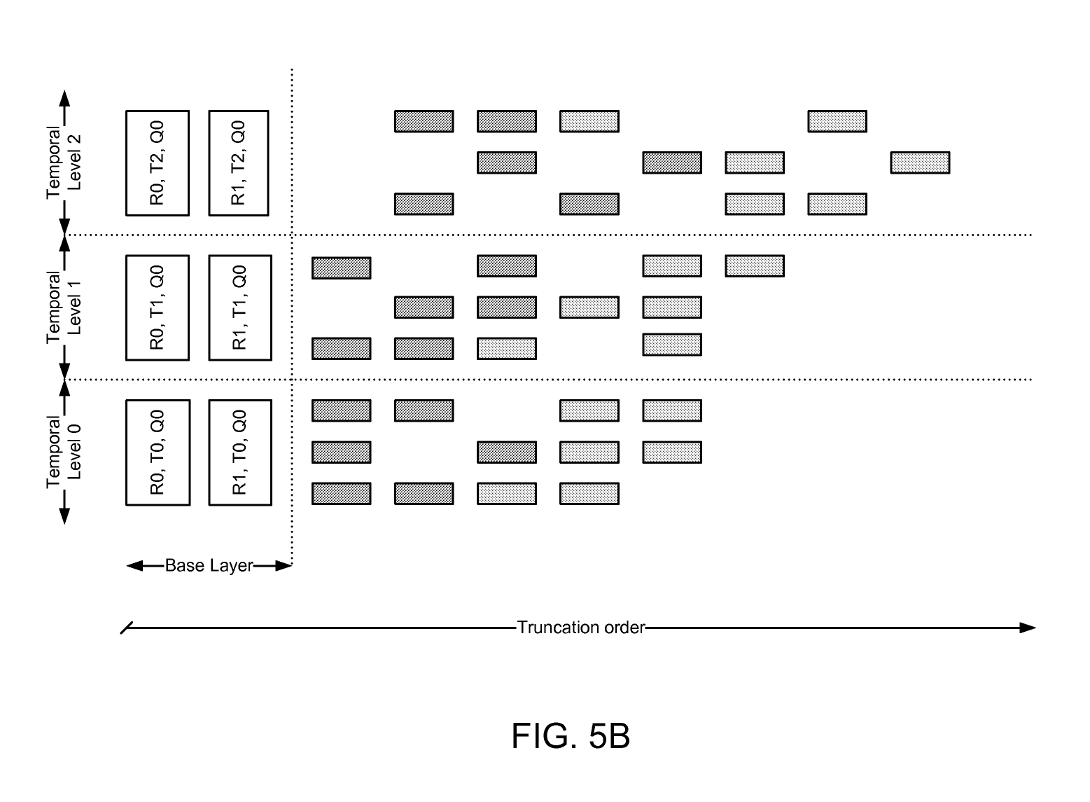

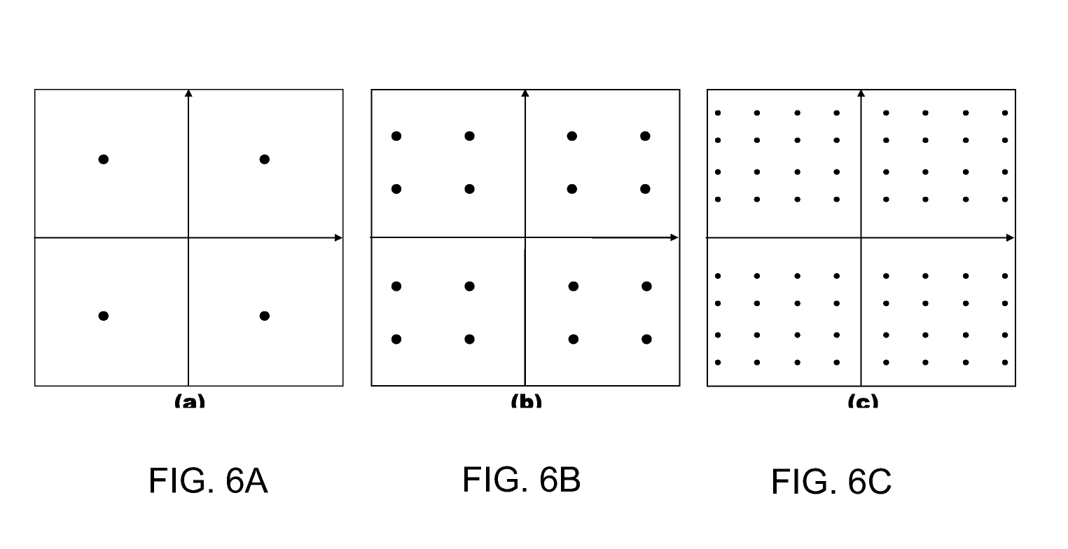

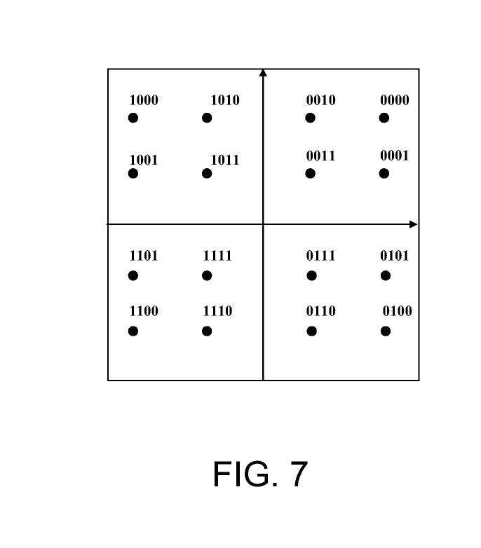

FIGS. 5A and 5B illustrate one such example, where FIG. 5A illustrates a priority mechanism for NAL units using basic extraction methods. In other words, the amount of bits from FGS pictures in different temporal levels are consistent from picture to picture. FIG. 5B illustrates an example of quality layer-based extraction, whereby the amounts of bits from FGS pictures is not uniform across the different temporal levels. Consequently, the way in which the HP and LP bits are associated to layers and FGS portions may also change from picture to picture. It should be noted that FIGS. 4, 5A, and 5B have been reproduced from ftp3.itu.ch/av-arch/jvt-site/2006_{—}10_Hangzhou/JVT-U144.zip and ftp3.itu.ch/av-arch/jvt-site/2006_{—}10_Hangzhou/JVT-U145.zip.

The various embodiments of the present invention are described herein with reference to a single, scalable media stream. In practice, as noted above, most streaming services include at least two real-time components, e.g., audio and video, which should be transmitted synchronously. Therefore, instead of LP/HP bit allocation for single media, a joint allocation to all streams in the same service can be made in accordance with the processes described above. Any number of streams in a service may be scalable and fine-granular scalable. Hence, the HP bits can contain at least the base layer of each media stream that is considered essential for the basic quality of the service.

In addition, the modulation method described above, can provide more than two hierarchy levels. That is, there are two possible methods that can be utilized in conjunction with the various embodiments of the present invention for mapping the coding layer hierarchy to the modulation layer hierarchy: According to one embodiment, a coded stream may consist of a base layer and any number of fine-granular scalable layers, where the bits are filled in according to the dependency order in the coded media stream. In other words, a first FGS layer is completely included before any data in a second FGS layer is included. According to another embodiment, each hierarchical level corresponds to one of the following: a base layer; a spatial enhancement layer; or a coarse granular enhancement layer. Because these layers may not precisely match the bitrate share given for the level of hierarchy in the modulation method, each one of these layers is associated with an FGS layer that is predicted from the base/spatial/CGS layer carried in the same bits of the modulation hierarchy. A receiver chooses which base/spatial/CGS layer is received or can be received correctly and uses its FGS enhancement to further improve the picture quality.

The present invention is described in the general context of method steps, which may be implemented in one embodiment by a program product including computer-executable instructions, such as program code, executed by computers in networked environments. A computer-readable medium may include removable and non-removable storage devices including, but not limited to, Read Only Memory (ROM), Random Access Memory (RAM), compact discs (CDs), digital versatile discs (DVD), etc. Generally, program modules include routines, programs, objects, components, data structures, etc. that perform particular tasks or implement particular abstract data types. Computer-executable instructions, associated data structures, and program modules represent examples of program code for executing steps of the methods disclosed herein. The particular sequence of such executable instructions or associated data structures represents examples of corresponding acts for implementing the functions described in such steps. For example, although DVB-H and SVC standards/systems were described herein as standards/systems within which the various embodiments of the present invention can be utilized, the various embodiments of the present invention are also applicable to other standards/systems, such as MediaFLO and Multimedia Broadcast Multicast Service (MBMS) systems.

The foregoing description of embodiments of the present invention have been presented for purposes of illustration and description. It is not intended to be exhaustive or to limit the present invention to the precise form disclosed, and modifications and variations are possible in light of the above teachings or may be acquired from practice of the present invention. The embodiments were chosen and described in order to explain the principles of the present invention and its practical application to enable one skilled in the art to utilize the present invention in various embodiments and with various modifications as are suited to the particular use contemplated. The features of the embodiments described herein may be combined in all possible combinations of methods, apparatus, computer program products and systems.

Software and web implementations could be accomplished with standard programming techniques with rule based logic and other logic to accomplish the various database searching steps, correlation steps, comparison steps and decision steps. It should also be noted that the words “component” and “module” as used herein and in the claims, is intended to encompass implementations using one or more lines of software code, and/or hardware implementations, and/or equipment for receiving manual inputs.

What is claimed is:

1. A method of generating a carrier wave signal using a hierarchical modulation mode, the hierarchical modulation mode being configured to convey a high priority stream and a low priority stream, comprising:
encoding a first media signal to a first media bitstream comprising at least two layers,wherein:
a first layer and a first portion of a second layer are configured for transmission within the high priority stream; and
a second portion of the second layer is configured for transmission within the low priority stream.

2. The method of claim 1, wherein the first layer comprises a base layer of the first media bitstream and the second layer comprises a fine grained scalability enhancement layer of the first media bitstream.

3. The method of claim 1, wherein a bitrate of the first layer does not exceed a limit derived from a bitrate of the high priority stream.

4. The method of claim 3, wherein the limit derived from the bitrate of the high priority stream is also derived from a time-slice burst frequency for the carrier wave signal.

5. The method of claim 3, further comprising encoding a third layer if the encoding of the second layer is insufficient to satisfy an assumed share of high priority bits and low priority bits available for the encoding of the second layer.

6. The method of claim 3, further comprising adjusting the bitrate of the first layer and a bitrate of the second layer to comply with a desired bitrate share, reflected by a number of high priority bits used for encoding the first layer and a number of low priority bits used for encoding the second layer, by including the first portion of the second layer in the encoding of the first layer, the first portion of the second layer comprising a leading portion.

7. The method of claim 3, further comprising adjusting the bitrate of the first layer and a second bitrate of the second layer to comply with a desired bitrate share, reflected by a number of high priority bits used for encoding the first layer and a number of low priority bits used for encoding the second layer, in accordance with a received bitrate share.

8. The method of claim 1, further comprising encoding a second media signal to a second media bitstream, wherein the second media bitstream is additionally configured for transmission within the high priority stream.

9. A computer program product, embodied on a computer-readable medium comprising computer code for performing the processes of claim 1.

10. An encoding apparatus, comprising:
a processor; and
a memory unit communicatively connected to the processor and including:
computer code for encoding a first media signal to a first media bitstream comprising at least two layers, wherein:
a first layer and a first portion of a second layer are configured for transmission within a high priority stream; and
a second portion of the second layer is configured for transmission within the low priority stream, wherein the high priority stream and the low priority stream are to be conveyed by a carrier wave signal generated using a hierarchical modulation mode.

11. The apparatus of claim 10, wherein the first layer comprises a base layer of the first media bitstream and the second layer comprises a fine grained scalability enhancement layer of the first media bitstream.

12. The apparatus of claim 10, wherein a bitrate of the first layer does not exceed a limit derived from a bitrate of the high priority stream.

13. The apparatus of claim 12, wherein the limit derived from the bitrate of the high priority stream is also derived from a time-slice burst frequency for the carrier wave signal.

14. The apparatus of claim 12, wherein the memory unit further comprises computer code for encoding a third layer if the encoding of the second layer is insufficient to satisfy an assumed share of high priority bits and low priority bits available for the encoding of the second layer.

15. The apparatus of claim 12, wherein the memory unit further comprises computer code for adjusting the bitrate of the first layer and a bitrate of the second layer to comply with a desired bitrate share, reflected by a number of high priority bits used for encoding the first layer and a number of low priority bits used for encoding the second layer, by including the first portion of the second layer in the encoding of the first layer, the first portion of the second layer comprising a leading portion.

16. The apparatus of claim 12, wherein the memory unit further comprises computer code for adjusting the bitrate of the first layer and a bitrate of the second layer to comply with a desired bitrate share, reflected by a number of high priority bits used for encoding the first layer and a number of low priority bits used for encoding the second layer, in accordance with a received bitrate share.

17. The method of claim 10, further comprising encoding a second media signal to a second media bitstream, wherein the second media bitstream is additionally configured for transmission within the high priority stream.

18. A method of receiving a carrier wave signal generated using a hierarchical modulation mode, the hierarchical modulation mode being configured to convey a high priority stream and a low priority stream, comprising:
decoding a first media bitstream comprising at least two layers from a first media signal, wherein:
a first layer and a first portion of a second layer are decoded from the high priority stream; and
a second portion of the second layer is decoded from the low priority stream.

19. The method of claim 18, wherein the first layer comprises a base layer of the first media bitstream.

20. The method of claim 18, wherein the second layer comprises a fine grained scalability enhancement layer of the first media bitstream.

21. The method of claim 18, further comprising decoding a third layer if a number of low priority bits used for encoding the second layer are insufficient to satisfy an assumed share of high priority bits and the low priority bits available for the encoding of the second layer.

22. The apparatus of claim 18, wherein the memory unit further comprises computer code for decoding a second media bitstream from a second media signal, wherein the second media bitstream is additionally configured for transmission within the high priority stream.

23. A computer program product, embodied on a computer-readable medium comprising computer code for performing the processes of claim 18.

24. A decoding apparatus, comprising:
a processor; and
a memory unit communicatively connected to the processor and including:
computer code for decoding a first media bitstream comprising at least two layers from a first media signal, wherein:
a first layer and a first portion of a second layer are decoded from the high priority stream; and
a second portion of the second layer is decoded from the low priority stream, wherein the high priority stream and the low priority stream have been conveyed by a carrier wave signal generated using a hierarchical modulation mode.

25. The apparatus of claim 24, wherein the first layer comprises a base layer of the first media bitstream.

26. The apparatus of claim 24, wherein the second layer comprises a fine grained scalability enhancement layer of the first media bitstream.

27. The apparatus of claim 24, wherein the memory unit further comprises computer code for decoding a third layer if a number of low priority bits used for encoding the second layer are insufficient to satisfy an assumed share of high priority bits and the low priority bits available for the encoding of the second layer.

28. The apparatus of claim 24, wherein the memory unit further comprises computer code for decoding a second media bitstream from a second media signal, wherein the second media bitstream is additionally configured for transmission within the high priority stream.

29. A system for generating a carrier wave signal, comprising:
a hierarchical modulator configured to convey a high priority stream and a low priority stream; and
an encoder configured to encode a first media signal to a first media bitstream comprising at least two layers, wherein:
a first layer and a first portion of a second layer are configured for transmission within the high priority stream; and
a second portion of the second layer is configured for transmission within the low priority stream.

30. The system of claim 29, wherein the first layer comprises a base layer of the first media bitstream.

31. The system of claim 29, wherein the second layer comprises a fine grained scalability enhancement layer of the first media bitstream.

32. A carrier wave signal modified according to a hierarchical modulation mode, the hierarchical modulation mode being configured to convey a high priority stream and a low priority stream, comprising:
a first media signal encoded to a first media bitstream comprising at least two layers, wherein:
a first layer and a first portion of a second layer are configured for transmission within the high priority stream; and
a second portion of the second layer is configured for transmission within the low priority stream.

33. The system of claim 32, wherein the first layer comprises a base layer of the first media bitstream.

34. The system of claim 32, wherein the second layer comprises a fine grained scalability enhancement layer of the first media bitstream.
